(19) United States
(12) Patent Application Publication
(10) Pub. No.: US 2012/0031313 A1
(43) Pub. Date: Feb. 9, 2012

(54) LOW DOSE METHODS FOR CONTROLLING INSECT PESTS

(75) Inventors: Bob Vernon, Chilliwack (CA); Wim Van Herk, Agassiz (CA)

(73) Assignee: Saskatoon Research Centre, Saskatoon, Saskatchewan (CA)

(21) Appl. No.: 13/124,312

(22) PCT Filed: Oct. 14, 2009
(86) PCT No.: PCT/CA09/01452

§ 371 Date: Jun. 22, 2011

Related U.S. Application Data
(60) Provisional application No. 61/105,504, filed on Oct. 15, 2008.

(51) Int. Cl. A01P 7/04; A01C 7/00; A01N 25/26

(52) U.S. Cl. 111/100; 504/100

(57) ABSTRACT

Methods of combining seeds that have been differentially treated with various single or blended insecticides and/or other additives for low risk attract-and-kill or push-pull strategies for the management of insect pests such as wireworms are disclosed. A combination of seeds for controlling insect pests is also disclosed. The combination comprises a First seed treated with one or more insecticides; and a Second seed for attracting and/or directing soil insect pests to the First seed. The invention describes various combinations of First and Second seeds, where pest insects are directed to ultimately end up at the First seeds that have been treated with a lethal insecticide, and the Second seeds act in various ways to increase control efficacy by attracting and/or directing the pest insects to the First seeds.

### FIELD OF INVENTION

The invention relates to methods of combining seeds that have been differentially treated and the combinations thereof for controlling insect pests, and more specifically to combinations of seeds that generally require a reduced pesticide dosage for controlling insect pests.

### BACKGROUND

Pesticides may be applied to seeds of a wide variety of plant crops to control a variety of pests, including diseases (fungicides), insects (insecticides), nematodes (nematocides), etc. The strategy of only applying the pesticide to seeds, referred to as a seed treatment, which is the general target area for initial pest attack after planting, requires less pesticide in a more efficient manner than applying pesticides using other application approaches, such as broadcasted or banded liquid or granular pesticide applications to the surrounding soil.

Certain polyphagous soil-dwelling insects, such as wireworms (the larval stage of several species of click beetles, Coleoptera:Elateridae), are attracted to CO₂ produced by germinating plant seeds, such as wheat (Doane et al. 1975). Furthermore, it has been shown that by planting seeds of a cereal crop such as wheat in rows between 0.5 and 1.0 m apart, the number of wireworms that are attracted to the germinating seeds in those rows increases as the density or quantity of the seed in those rows increases (Vernon et al. 2000). This is because as seed density increases, CO₂ production per unit of planted row increases, and the ability of wireworms to locate the seeded rows improves. Wireworms have also been shown to be equally attracted to most cereal crops (i.e. wheat, barley, rye and oats) and varieties of wheat tested (Vernon et al. 2003).

It has been observed that when the seed of a cereal crop is treated with the organochlorine insecticide lindane, the number of wireworms that are attracted to the cereal crop rows increases with seeding density (Vernon 2005). Furthermore, as seeding density increases, the proportion of attracted wireworms that ultimately die from exposure to the lindane seed treatment also increases (Vernon 2005). This is likely the result of an increase in lindane per unit area of seeded row, and a corresponding increase in wireworm exposure. An ‘Attract-and-Kill’ (A&K) strategy, involving lindane-treated wheat seed, has been used by growers in Canada to reduce wireworm populations in advance of, or concurrent with (as A&K companion crops) the planting of other crops susceptible to wireworm attack (i.e. potatoes, strawberries). However, this strategy had to be abandoned when lindane was banned in Canada and other countries after the year 2000.

Neonicotinoid insecticides have been considered potential replacements for lindane and other insecticides for control of wireworms in several crops. However, it has recently been found that neonicotinoid insecticides (i.e. thiamethoxam, imidacloprid, clothianidin and acetamiprid) applied topically to various wireworm species result in wireworms rapidly becoming intoxicated rather than immediately dying. It was also found that wireworms can remain in this intoxicated (moribund) state for a prolonged period of time (several months), during which time they do not feed. At high doses, wireworms will die after a period of morbidity. However, at sub-lethal doses, moribund wireworms ultimately recover fully (Vernon et al. 2008, van Herk et al. 2008).

Furthermore, neonicotinoid insecticides applied to wheat seed at registered rates, have been found in field trials to significantly reduce crop damage, however, population levels of wireworms are not significantly reduced as with other formerly used insecticides (e.g. lindane) (Vernon et al. 2006). It has been concluded that wireworms coming in contact with the neonicotinoid seed treatments become intoxicated long enough for the crop to become well established (stand and yield protection), but populations later recover, often to their original levels.

In potatoes, it has also been shown that potato seed treated with neonicotinoid insecticides may intoxicate wireworms long enough to provide some protection of daughter tubers at harvest (3 months after planting), but effectiveness varies depending on the wireworm species involved. In these potato trials, wireworm populations later recovered to their original levels (Vernon et al. 2006). These wheat and potato data showed that the dosages of neonicotinoid insecticides, registered as seed treatments, are sub-lethal to the majority of wireworms exposed under field conditions.

The fact that neonicotinoids applied as seed piece treatments may provide crop protection from wireworm damage (during the intoxication period at which time wireworms do not feed), and yet do not reduce wireworm populations due to sub-lethal exposure, is of profound importance to the long term management of wireworm populations in agriculture, since without repeated treatment, the unreduced wireworm populations can still cause significant damage to crops over multiple seasons. This is because the destructive wireworm stage can last from 3-6 years in the soil, depending on the species, during which time subterranean feeding can occur on a wide variety of crops. Fields infested with wireworms may also have several larval life stages represented at any particular time. If wireworm populations are not significantly reduced in a crop treated with neonicotinoid insecticides, they will be present the following year and can damage subsequent crops unless additional control measures are taken.

Another important consideration related to wireworm control is the effect that soil insecticides or seed treatments have on new, or ‘neonate’, wireworm populations produced during the year of insecticide treatment. In several crops, and especially cereals, fields are invaded during spring and summer months by click beetles, the adult stage of wireworms. Click beetles, although causing no damage to the crop, lay eggs which hatch into neonate wireworms. These neonates feed on a variety of living and non-living materials in the field depending on the species involved, and are about 0.5 cm long by the end of the first summer. In general, wireworms will grow about 0.5 cm each year until they pupate in their final year (3-6 years depending on species) and produce adults. It has recently been found that wheat seed treated with the now banned lindane not only would reduce populations of larger sized wireworms (‘maturing wireworms’), but would also dramatically reduce populations of neonates in the year of treatment (Vernon et al. 2006).

The phenyl pyrazol insecticide fipronil has also been registered in several countries for control of wireworms and other pests in a number of crops (i.e. corn, potato). It has been shown that when fipronil is applied topically to wireworms, wireworms are quickly immobilized and rapidly die when exposed to high doses. What is interesting, however, is that wireworms exposed to extremely low doses behaved normally for several months (feeding, moulting, etc.), but then became moribund and ultimately died (Vernon et al. 2008; van Herk et al. 2008). This low dose mortality effect is termed ‘latent mortality’. Furthermore, fipronil applied at experimental rates to wheat seed, or to potato crops as an in-furrow spray, provided excellent crop protection and virtually eliminated populations of larger (maturing) and newly produced (neonate) wireworm populations from treated plots (Vernon et al. 2006).

However, a problem associated with fipronil is that it is more toxic to wildlife and humans than the neonicotinoids. Another problem is that fipronil is more persistent in soil than the newer generation insecticides such as the neonicotinoids, and the recommended dosages applied for wireworm control in various crops in some countries is of concern.

Other candidates for the control of wireworms and other soil insects are certain synthetic pyrethroids, including tefluthrin, bifenthrin and lambda cyhalothrin. It has recently been discovered, however, that tefluthrin and bifenthrin are repulsive to various wireworm species under laboratory conditions and therefore in general is not consumed by wireworms in a dosage sufficient to result in death. After a short period of morbidity, repulsed wireworms will recover fully and then seek new seeds (van Herk and Vernon 2007). It has also been found that tefluthrin applied as a wheat seed treatment, although providing good wheat stand and yield protection, does not ultimately reduce wireworm populations in the field. Research underway also suggests that other synthetic pyrethroids have similar effects on wireworms.

A major problem associated with the use of synthetic pyrethroids such as tefluthrin for use against wireworms, therefore, is that they may not adequately reduce wireworm populations. Wireworms would then be present in subsequent years at which time additional controls would be required.

A need therefore exists to provide a product and method for protecting crops from damage and/or reducing populations of insect pests such as wireworms which overcomes one or more of the drawbacks outlined above or is observed in the industry.

### SUMMARY

Methods of combining seeds that have been differentially treated and the combinations thereof for controlling insect pests are provided. Combinations of seeds that generally require a reduced pesticide dosage for controlling insect pests, such as wireworm, are also provided.

In one embodiment there is provided a combination of seeds for controlling insect pests, the combination comprising:
a first seed treated with one or more insecticides; and
a second seed for attracting and/or directing insect pests to the first seed.

In another embodiment there is provided a method of controlling insect pests in crops comprising:
planting a first seed treated with one or more insecticides, and planting a second seed for attracting and/or directing the insect pests toward the first seed.

In another embodiment there is provided a seed package for reducing insecticide exposure to the environment comprising:
a seed combination for sowing comprising a first seed treated with an insecticidal active dose of one or more insecticides and a second seed for attracting and/or directing insects to the first seed.

In another embodiment there is provided a method of increasing the yield and quality of crop plant, the method comprising:
sowing a crop plant propagation material;
sowing companion plant propagation comprising a first treated plant propagation material wherein the first treated plant propagation material is treated with an insecticidal mixture comprising a neonicotinoid insecticide and a phenylpyrazol insecticide.

In another embodiment there is provided a method of increasing the yield and quality of crop plant, the method comprising:
sowing a crop plant propagation material;
   sowing companion plant propagation comprising a first treated plant propagation material and a second treated plant propagation material, wherein the first treated plant propagation material is treated with an insecticidally active dose of one or more insecticides, and wherein the second treated plant propagation material is treated with an agent for attracting and/or directing insects toward the first treated plant propagation material.

### DETAILED DESCRIPTION

A method of managing insect pests for crop protection, and a combination of differentially-treated seeds for carrying out management of insect pests for crop protection are provided. Management of insect pests resulting in crop protection may be achieved by maintaining the crop (including for example protection of the crop stand, preservation of the crop yield and quality or prevention of crop contamination), reducing the population of insect pests, or combinations thereof.

In one embodiment there is provided a seed combination for management of soil insect pests, such as for example wireworrms. Other soil-borne invertebrate pests controlled by the compositions include, without limitation, any pests that are attracted to seed or other propagation material that produces an attractant, or which, in combination with other organisms resident or introduced to the soil, produces an attractant, such as nematodes, pillbugs, millipedes, centipedes, earwigs, seed corn maggot, cabbage root maggot, turnip maggot, corn rootworms, such as southern corn rootworm, western corn rootworm, Mexican corn rootworm, and spotted corn rootworm; white grubs, corn root aphids, cutworms, such as black cutworm, granulate cutworm, and varigated cutworm; june beetles, chafers, hunting billbugs, lesser cornstalk borer, mole crickets, such as tawny mole cricket and southern mole cricket; white-fringed beetle, seed corn beetles; corn root aphids, sod webworm, as well as other soil-borne invertebrate pests.

The seed combination includes a First seed and a Second seed, where soil insect pests are directed to ultimately end up at the First seed that has been treated with one or more pesticides that are lethal to the insect pests, and the Second seed is treated with an agent that acts in various ways to maximize efficacy by attracting and/or directing the insect pests to the First seed where the soil insect pests are exposed to a lethal dosage of pesticide.

Thus, as used herein the term “First”, “First seed” or “First treated seed” is meant to include any seed that has been treated with one or more pesticides that are meant to provide crop protection from soil insect pests. In addition, the First seed can be treated with one or more non-insecticidal pesticides that confer protection against various non-insect pests, and/or additives that promote the growth and health of the seed so as to maximize CO₂ or other attractant production. A primary additive may include one or more pesticides that will provide specific crop protection and pest population control requirements related to one or more insect pests. The First seed may also contain natural or introduced genetic material that provides crop protection from soil insect pests, soil insect pest mortality, and/or that promotes the growth and health of the seed so as to maximize CO₂ or other attractant production.

The term “Second”, “Second seed” or “Second treated seed” as used herein is meant to include any seed treated or not treated with an agent including one or more pesticides and/or other additives whose function is for attraction of the soil insect pests to the seeded rows and to either passively or intentionally direct the soil insect pests to the First seed.

A third seed may be included in the combination of seeds. The term “Third”, “Third seed” or “Third treated seed” as used herein is meant to include any seed treated or not treated with an agent including one or more pesticides and/or other additives whose function is for attraction of the soil insect pests to the seeded rows and to either passively or intentionally direct the soil insect pests to the First seed. In all cases, in the use of the term First seed, Second seed and Third seed, both the singular and plural are implied, i.e. seed or seeds.

The combination of First and Second seeds allows for the rates of pesticide active ingredients to be reduced by differentially treating only fractions of seed with active ingredients designed to manipulate insect behaviour (Second seed) and ultimately kill (First seed) pest insects in the soil to achieve crop protection. A variety of pesticides may be used either individually or in combination in treating the First seed with either a single or blended pesticide. The Second seed can be treated with one or more non-insecticidal pesticides that confer protection against various non-insect pests, such as plant diseases, and/or additives that promote the growth and health of the seed so as to maximize CO₂ or other attractant production. The Second seed may also contain natural or introduced genetic material that promotes the growth and health of the seed so as to maximize CO₂ or other attractant production. The Second seed may also be treated with a pesticide or blend of pesticides different to those used in treating the First seed, or may alternatively or additionally be treated with an additive or agent useful in manipulating insect behaviour. The combination of seeds may be used in attract-and-kill and/or push-pull strategies for the management of soil insect pests.

One illustrative seed treatment strategy includes the application of one or more pesticides to an allotment of seed. The treated allotment of seed is thoroughly mixed with one or more other allotments of seed that have been treated with one or more different pesticides or additives. In the case of wireworm control, First seeds may be treated with one or more pesticides that are meant to provide crop protection from wireworm damage and/or, reduce populations of mature and/or neonate wireworms in the field. Second seeds may be treated with one or more pesticides and/or other additives whose main function(s) is to increase the attraction of wireworms to seeded rows and to either passively or intentionally direct wireworm populations to the First seeds.

A ‘seed’, as used in the terms First seed, Second seed or Third seed, covers all kinds of seed that can be treated with pesticides or other additives for agricultural purposes, such as, but not confined to, cereal crops, forage crops, pulses, potatoes, and various vegetables. As will be appreciated by one of skill in the art, the principal, however, may extend to any other plant propagation living materials such as cuttings, pieces (as in potatoes), and so on. Therefore, as used herein, the term “seed” means any plant propagation material. The seed or propagation material may also contain natural or introduced genetic material that provides crop protection from insect pests including soil insect pests, or confers additional advantages to one or more components of the crop propagation mixture. In addition, First seeds and Second seeds do not have to be of the same variety or species, provided they accomplish their respective roles in controlling the targeted pests and their damages.

Where only the protection of crop stand, preservation of crop yield and quality or prevention of crop contamination is desired, such as but not limited to cereal crops, forage crops, pulses, potatoes and various vegetables, the First seeds may be treated with various neonicotinoid insecticides, for example but not limited to thiamethoxam, clothianidin and imidacloprid. These neonicotinoids provide protection through long term intoxication of wireworm populations. Other neonicotinoid insecticides (such as, but not restricted to acetamiprid, thiacloprid, nithiazine, nitenpyram) that may produce similar effects on wireworms can be substituted. Wireworms encountering the neonicotinoid treated First seed typically become intoxicated or moribund long enough for the crop to become established and produce an acceptable yield. Wireworm populations, however, will mostly recover to their previous levels by the end of the growing season.

Thiamethoxam is an insecticide, described, for example, in The UK Pesticide Guide, 20^{th} Ed. 2007. CABI International and British Crop Protection Council, UK. Pages 510-511. It has been found that rates of thiamethoxam active ingredient ranging from about 5.0 g to about 30.0 g a.i./100 kg seed are effective in reducing wireworm damage to cereal crops (i.e. wheat, barley, oats and rye) depending on wireworm population size and species.

Clothianidin is an insecticide, described, for example, in The UK Pesticide Guide, 20^{th} Ed. 2007. CABI International and British Crop Protection Council, UK. Pages 191-192. It has been found that rates of clothianidin active ingredient ranging from about 10.0 g to about 30.0 g a.i./100 kg seed are effective in reducing wireworm damage to cereal crops (i.e. wheat, barley, oats and rye) depending on wireworm population size and species.

Imidacloprid is an insecticide, described, for example, in The UK Pesticide Guide, 20^{th} Ed. 2007. CABI International and British Crop Protection Council, UK. Pages 345-347. It has been found that rates of imidacloprid active ingredient ranging from about 10.0 g to about 30.0 g a.i./100 kg seed are effective in reducing wireworm damage to cereal crops (i.e. wheat, barley, oats and rye) depending on wireworm population size and species.

For reducing populations of wireworms in a crop or field, such as, but not limited to, a conventional cereal crop, forage crop, pulse crop, etc., by the use of a lethal trap crop (i.e. wheat, barley, oats, rye) planted solely to reduce wireworm populations, First seeds of wheat can be treated with an insecticide known to cause either rapid (within 2 weeks of exposure), or latent (greater than 2 weeks after exposure) mortality of wireworms, which will kill either the maturing population, the neonate population, or both. It has been found that First seeds treated with fipronil alone may be used to accomplish all of these purposes. For rapid intoxication and death of maturing wireworms in cereal crops, it has been found that rates of fipronil active ingredient ranging from 0.5 g to 50.0 g a.i./100 kg seed significantly reduced heavy wireworm populations. To adequately protect the crop from significant damage under moderate to high wireworm pressure, however, fipronil may be applied at rates at or above 5.0 g a.i./100 kg seed. To more significantly reduce neonate wireworm populations which arise later in the growing season, fipronil active ingredient ranging from about 0.5 g to about 1.0 g a.i./100 kg seed in cereal crops may be applied.

Fipronil is an insecticide described, for example in The UK Pesticide Guide, 20^{th} Ed. 2007. CABI International and British Crop Protection Council, UK. Page 301.

For protecting a crop from the various damages caused by wireworms, as well as to reduce maturing and neonate wireworm populations, and to do so with a reduced amount of individual insecticides relative to broadcasted or banded liquid or granular pesticide applications to the surrounding soil, it has been found that First seeds treated with a mixture of, for example, a neonicotinoid (e.g. thiamethoxam) plus fipronil will accomplish these purposes. In such mixtures, the primary purpose of the neonicotinoid is to protect the crop from maturing wireworm population feeding by intoxicating wireworms through the initial destructive period of feeding. In the mixture, the primary purpose of fipronil is to kill both the maturing and neonate wireworm populations in proximity to the seed or surrounding soil through immediate poisoning and/or latent toxicity. A secondary purpose of fipronil is to provide additional crop protection from maturing wireworm population feeding through intoxication and death. In most cases a mixture containing a neonicotinoid (e.g. thiamethoxam) at between about 5.0 and about 10.0 g a.i./100 kg seed, and fipronil at between about 0.5 and about 5.0 g a.i./ 100 kg seed is sufficient. The advantage of the neonicotinoid in the mixture is primarily to provide acceptable crop protection from wireworm damage, which would not be acceptable with fipronil alone at rates between about 0.5 and 1.0 g a.i./100 kg seed.

Seed additives that may be applied to Second seeds may comprise one or more non-insecticidal pesticides that confer protection against various non-insect pests (such as plant pathogens, nematodes, etc), and/or additives that promote the growth and/or health of the seed so as to maximize CO₂ or other attractant production. It will be appreciated that enhanced CO₂ production attracts wireworms. Other additives may include one or more lethal or sub-lethal pesticides or other insect behaviour modifying chemicals. One objective of these additives is to maximize the attraction of soil insect pests, such as wireworm populations, to seeded rows, and thereafter to direct the insect pests to the First seeds and consequent exposure to lethal pesticide(s).

The primary purpose of Second seeds is to work in conjunction with the First seeds in attracting wireworms and/or other soil insect pests to the seeded rows by increasing the amount of CO₂ or other attractants produced. It is known that wireworm attraction to seeded rows (i.e. cereal crops) increases as the density of seed increases. In the case of a lethal trap crop strategy, where the objective is to kill as many wireworms as possible in the field, but not necessarily to preserve the crop, the presence of non-lethal Second seeds serve to increase wireworm attraction without having to increase the amount of First seeds and by result increase the amount of pesticide used and exposed to the environment. Fewer First seeds translates to less active ingredient required to kill wireworm populations, and therefore, to less environmental and human risk and impact. Additionally, a cost savings may be observed as less pesticide per unit area is needed.

Optionally, Second seeds may not contain any added behaviour modifying chemicals, such as attractants or repellents, and may serve only the purpose of attracting soil insect pests, such as wireworms, to the seeded rows through the natural production of CO₂ or other attractants. Soil insect pests, such as wireworms, that would encounter these Second seeds would generally consume the seed and then move to adjacent seeds until they encounter a First seed, at which time they would be exposed to a suitable pesticide dosage and be killed. One interesting and unpredictable feature of these non-treated (that is, no pesticides or behaviour modifying chemicals) Second seeds, is that the higher the wireworm population, the higher the ratio of Second seeds to First seeds can be used to achieve population reduction. This is because wireworms may generally consume several germinating Second seeds (i.e. in the case of cereal crops), but do not generally consume enough of the First seeds to reduce First seed germination before they become intoxicated and subsequently die. Mixing ratios of Second to First seeds of about 1:10 to 10:1 may be formulated to achieve targeted levels of soil insect pest mortality and damage control according to the anticipated population levels of soil insect pests, such as wireworms, in the field, and according to the objective(s) of planting the seed. For example, in the case of a lethal trap crop intended solely to reduce maturing wireworm populations where wireworms are known to be present in high numbers, a Second to First seed ratio of about 10:1 may be used, in which case the majority of Second seeds would be rapidly consumed, leaving only the First seeds to feed upon. Neonate wireworm populations, that would be produced later in the growing season, would be killed by the surviving First seeds. In this case, damaging wireworm populations in the field would be greatly reduced, and significant damage from future wireworm populations would not be expected for 3 years, during which time wireworm controls would not be required.

In the case of a cereal crop where maximum stand and high yield as well as a reduction of high populations of maturing and neonate populations of wireworms are objectives, a Second to First seed ratio of about 1:10 may be used. In this case, only about 10% of the crop would be destroyed, and damaging wireworm populations would be greatly reduced for 3 years. Another interesting and surprising feature of these non-treated (that is, no pesticides or behaviour modifying chemicals) Second seeds, is that when a non-treated Second seed is adjacent to a First seed, wireworms are less likely to damage the Second seed, even if they arrive at the Second seed first. This is due to the toxic effects of First seeds on wireworms extending to the nearby Second seeds. In laboratory soil bioassays, wireworms generally appear more agitated and exhibit reduced feeding activity in the presence of alternating First and non-treated Second seeds.

An additive for Second seeds may also comprise various behaviour modifying chemicals, such as short range repellents, that would ultimately direct the movement of wireworms to the First seeds. One example of a treatment strategy is to treat Second cereal seeds with a synthetic pyrethroid (SP) such as tefluthrin. The tefluthrin-treated Second seeds would produce CO₂ during the germination process which would attract wireworms to the seeded rows. Upon contact with the Second seeds, the wireworms would be repulsed by the tefluthrin, and would follow other CO₂ trails that would ultimately lead them to the First seeds where they would be killed. Second seeds treated with tefluthrin at between about 5 and 10 g a.i./100 kg seed are suitable for this purpose, and have been shown in the lab and field to be sub-lethal doses. Additional synthetic pyrethroids have been shown to be repulsive to various insects, and SPs that could be considered for use as additives on Second seeds include, but are not restricted to, allethrin, bifenthrin, cyfluthrin, cyhalothrin, cypermethrin, deltamethrin, esfenvalerate, fenpropathrin, fluvalinate, permethrin, resmethrin, tetramethrin and tralomethrin.

Tefluthrin is an insecticide, described, for example, in The UK Pesticide Guide, 20^{th} Ed. 2007. CABI International and British Crop Protection Council, UK. Page 499-501.

One advantage of using tefluthrin-treated Second seeds is that they are not generally consumed by wireworms before they are repelled. Therefore, in a situation where the objectives are to produce a crop with maximum stand and high yield as well as a reduction of high populations of maturing and neonate wireworms, as well as reducing the amount of First seed pesticide/hectare, a higher ratio of tefluthrin-treated Second seeds to First seeds may be used than with the non-treated (no pesticides or behaviour modifying chemicals) Second seeds (example given above). In this case, a mixing ratio of tefluthrin-treated Second seeds to First seeds between about 1:5 to 5:1 may be formulated to achieve targeted levels of crop protection and wireworm population reduction.

Another advantage of using tefluthrin-treated Second seeds with First seeds treated with one or more additional insecticides, especially where all insecticides are from different chemical classes and have different modes of action, is that the likelihood of insecticide resistance occurring to one or more of the insecticides is reduced.

Another embodiment provides for the mixing of a Third seed together with a Second and a First seed to accomplish specific objectives. For example, a mixture of a non-treated Third seed may be mixed with a tefluthrin-treated Second seed and mixed with First seeds in various ratios. If, for example, the objectives are to only partially preserve crop stand and yield from wireworm attack, to reduce maturing and neonate wireworm populations, and to reduce the amount of tefluthrin and First seed pesticide(s) used, then a mixture ratio of non-treated Third seed:tefluthin-treated Second seed:First seed, may range from about 1:1:1 to 5:1:1. To accomplish other objectives, the mixture may range from about 1:10:10; 10:10:1; 10:1:10, or any ratios in between.

Another embodiment provides for a reduced usage of pesticide active ingredient. Mixtures of Second and First seeds may be provided that reduce the risk of pesticide impact and exposure to the environment and the human population. This is especially important when considering that fipronil, which is registered in many countries for controlling wireworms, has some environmental concerns. Fipronil is registered for wireworm control in potatoes in the United States as an in-furrow spray at planting. The rate of fipronil active ingredient recommended is 112.1 g a.i./ha. However, it has been found that First wheat seeds treated with fipronil alone at 5.0 g a.i./100 kg seed, or with fipronil at 1.0 g a.i./100 kg seed combined with thiamethoxam at 10.0 g a.i./100 kg seed, and applied at planting in potato furrows in an attract-and-kill strategy at the rate of 3.0 First seeds/cm of row alongside potato seed, will adequately control damage to daughter tubers and significantly reduce wireworm populations. In the case of the fipronil plus thiamethoxam blend, the amount of fipronil active ingredient in the First seed would amount to only 0.8 g a.i./ha. If First seed is combined with untreated Second seed, or tefluthrin-treated Second seed at a 1:2 mixture ratio, the amount of fipronil active ingredient required is reduced to 0.27 g a.i./ha, or about 415 times less than with fipronil applied as an in-furrow spray application. It has also been determined that the planting rate of First seeds/cm of potato row can be reduced from 3.0 to 1.5 without loss of crop protection or wireworm population reduction. This suggests that the amount of fipronil active ingredient can even be reduced to below 0.27 g a.i./ha .

Mixtures of Second and First seeds may also be used in a lethal trap crop strategy, whereby maturing and neonate wireworm populations in a field are reduced by pre-emptively planting a mixture of Second and First seeds in rows spaced, for example, 1 m apart at a linear seeding density of about 1.5 seeds/cm. This can be accomplished, for example, using cereal crops (i.e. wheat, oats, barley, rye) comprised of a mixture of Second and First cereal crop seed.

Mixtures of Second and First seeds may be used in any number of combinations and ratios to reduce wireworm damage to various crops and/or to reduce wireworm populations. The ratios outlined above are merely examples of possible Second:First seed combinations and are not meant to be limiting.

Mixtures of Second and First seeds can be used to reduce wireworm damage and/or reduce wireworm populations in a conventionally planted crop which consists solely of the Second and First seeds. For example, cereal crops (i.e. wheat, oats, barley, rye) may be composed of cereal crop seed comprising a mixture of Second and First cereal crop seed.

Mixtures of Second and First seeds may also be used in trap crop strategies wherein the trap crop is planted in various ways in association with an additional crop. For example, the Second and First trap crop may be planted in rows between other crops, such as, but not limited to, strawberries, corn, potatoes, tobacco and sugar beets, to attract and kill wireworms, provided the trap crop strategy used is approved in the country of use with the additives involved.

Mixtures of Second and First seeds can also be applied in potato furrows at the time of planting to attract and kill wireworms, provided the attract and kill strategy used is approved in the country of use with the additives involved.

It will be appreciated that pesticides as used herein includes insecticides.

The present invention also includes the control of above ground insect pests as well, such as cabbage maggot flies, Delia radicum. For example, cabbage maggot flies select their hosts (i.e. broccoli, cauliflower, cabbage, etc) for oviposition (egg laying) based on the diameter of the stems. A mixture of First and Second seeds may be presented whereby the First seed is treated with a lethal blend of insecticide and has other additives to promote rapid germination and thicker stem girth. Second seeds would not have to be treated with the lethal blend, thus reducing the amount of pesticide required. The use of a Third seed in mixture for the control of above ground insect pests is also included in the present invention.

The invention will now be demonstrated with the following non-limiting examples.

### EXAMPLE 1

Wheat field trial 1 in 2007. The registered trademarks and other designations denote the following products: 1. Dividend@ XL RTA (Syngenta) Commercial seed treatment formulation of difenconazole; 2. Cruiser 350FS (Syngenta)

Commercial seed treatment formulation of thiamethoxam; 3. Regent 4SC (BASF) Commercial seed treatment formulation of fipronil.

Details: Number of Reps=4; Plot Size=6, 2.5 m long rows spaced 0.5 m apart; Plots separated by 1 m. Wheat variety Superb. Treatment list: Tmts 1, 2 and 3 consist of wheat seed treated with Dividend XL RTA at 13 g a.i./100 kg wheat seed (Second seed) and planted by hand at 1, 2 and 3 seeds per 1.75 cm of row, respectively; Tmts 4, 5 and 6 consist of wheat seed treated with a mixture of Dividend XL RTA at 13 g a.i., Cruiser 350FS at 10 g a.i. and Regent 4SC at 50 g a.i./100 kg wheat seed (First seed) and planted by hand at 1, 2 and 3 seeds per 1.75 cm of row, respectively; Tmts 7, 8 and 9 consist of a 1:1 ratio of Second:First seeds, planted by hand at a total of 1, 2 and 3 seeds per 1.75 cm of row, respectively; Tmts 10, 11 and 12 consist of a 2:1 ratio of Second:First seeds, planted by hand at a total of 1, 2 and 3 seeds per 1.75 cm of row, respectively. Crop protection determined by stand counts at 7, 14 and 21 days after planting in 2007, expressed as % emergence of precision-planted seed. Wireworm mortality determined by bait trap samples placed within individual plots the following spring, 2008. The trial conducted under moderate wireworm pressure, with Agriotes obscures the principal species.

Results. In treatments 1-12, the mean percent emergence/4 replicates was, respectively, 82.0, 90.0, 87.7, 96.1, 93.2, 95.3, 94.5, 92.4, 91.2, 94.6, 93.1, 93.9. In the 1 seed per 1.75 cm treatments (1, 4, 7, 10), treatments containing Second:First seeds at ratios of 0:1; 1:1 and 2:1 (Tmts 4, 7, 10) had % emergence significantly greater than the Second seed alone (Tmt 1). The presence of First seed (with the insecticide mixture) admixed with Second seed (no insecticides) reduced the expected mortality of the Second seed. In the spring following the 2007 trial, numbers of larger wireworms (>9 mm long) taken in bait traps were significantly higher in treatments containing only the Second seed (1, 2, and 3), than in all other treatments. Combined, mean larger wireworm counts/replicate in treatments 1-3, 4-6, 7-9, and 10-12 were, respectively, 4.33, 0.17, 0.25 and 0.17. Combined, mean smaller (neonate) wireworm counts/replicate in treatments 1-3, 4-6, 7-9, and 10-12 were, respectively, 0.42, 0.0, 0.0 and 0.17.

### EXAMPLE 2

Wheat field trial 2 in 2007. The registered trademarks and other designations denote the following products: 1. Dividend@ XL RTA (Syngenta) Commercial seed treatment formulation of difenconazole; 2. Cruiser 350FS (Syngenta) Commercial seed treatment formulation of thiamethoxam; 3. Regent 4SC (BASF) Commercial seed treatment formulation of fipronil; 4 Vitavax Dual (Gustafson/Bayer) Commercial seed treatment formulation containing lindane and carbathiin.

Details: Number of Reps=4; Plot Size=6, 2.5 m long rows spaced 0.5 m apart; Wheat variety Superb. All seed planted by hand at 1 seed/1.75 cm. All seed treatment rates expressed as grams a.i./100 kg wheat seed. Treatment list: Tmt 1 Dividend XL RTA at 13 g a.i.; Tmt 2 Vitavax Dual at 58.6 g a.i. lindane; Tmt 3 Cruiser 350FS at 10 g a.i.; Tmts 4-8 containing mixtures of Cruiser 350FS at 10 g a.i. with Regent 4SC at rates of 50.0, 5.0, 1.0, 0.5 and 0.1 g a.i., respectively ; Tmts 9-13 Regent 4SC at rates of 50, 5.0, 1.0, 0.5 and 0.1 g a.i., respectively. Crop protection determined by stand counts in the center 2 rows at 7, 14, 21 and 28 days after planting (DAP) in 2007, expressed as % emergence of precision-planted seed. Relative crop yield determined by cutting off all the wheat heads 1 mm below the wheat head in a 1.5 m length of rows 3 and 4 between 13 and 16 August, 2007, and counting and weighing the seed heads. Wireworm mortality determined by bait trap samples placed within individual plots the following spring, 2008. The trial conducted under moderate wireworm pressure, with Agriotes obscurus the principal species.

Results. Mean percentage wheat stand/replicate in Treatments 1-13 at 28 DAP were, respectively: 61.3, 84.3, 85.9, 93.8, 92.9, 91.6, 88.7, 88.5, 89.8, 90.1, 81.8, 85.3, 70.2. All wheat treated with the Cruiser 350FS plus Regent 4SC blends (Tmts 4-8) had acceptable stands at 28 DAP, with stands significantly greater than the Dividend only treatment (Tmt 1). Tmts 4-8 had numerically greater stands than wheat treated with Cruiser 350FS alone (Tmt 3) or Vitavax Dual (Tmt 2). Wheat treated with Regent 4SC at various rates (Tmts 9-13) had acceptable stands at 50.0 and 5.0 g rates, with declining stands (numerically less than Tmts 2 and 3) at lower rates. The mean mass of wheat seed heads per 1.5 m of row in Treatments 1-13 were 283.5, 334.7, 380.2, 423.1, 421.5, 400.9, 395.3, 392.2, 389.7, 394.1, 344.5, 354.0, 320.8. All treatments containing Cruiser 350FS alone and with Regent 4SC (Tmts 3-8), and Regent alone at the two highest rates (Tmts 9-10) had significantly higher weights than the Dividend only treatment (Tmt 1). Treatments containing Cruiser 350FS plus Regent 4SC at the 3 highest rates (Tmts 4-5) had significantly higher yields than the Vitavax Dual (Tmt 2) standard. Mean number of larger (>9 mm) wireworms/replicate taken in bait traps in spring, 2008 in Treatments 1-13 were, respectively, 6.5, 1.3, 5.3, 0.3, 0.3, 1.0, 1.5, 2.5, 0, 0.8, 0.5, 1.8, 5.5. Mean numbers of smaller wireworms/replicate (neonates<9 mm long) taken in bait traps in treatments 1-13 were, respectively, 2.8, 0.3, 3.0, 0.3, 0.3, 0.3, 0.3, 1.0, 0.5, 0.3, 0.5, 1.3, 2.0. The results show that mixtures of Cruiser 350FS and Regent 4SC in Tmts 4-7 (Regent 4SC rates of 50.0, 5.0, 1.0 and 0.5) provide both stand and yield protection and wireworm population reductions equal to or better than the Vitavax Dual standard (Tmt 2) or Cruiser 350FS (Tmt 3) alone, provide better stand protection than Regent 4SC alone in Tmts 11-13 (rates of 1.0, 0.5 and 0.1, respectively), and better wireworm reductions than in Tmts 12 and 13.

### EXAMPLE 3

Wheat field trial 3 in 2007. The registered trademarks and other designations denote the following products: 1. Dividend@ XL RTA (Syngenta) Commercial seed treatment formulation of difenconazole; 2. Cruiser 350FS (Syngenta) Commercial seed treatment formulation of thiamethoxam; 3. Regent 4SC (BASF) Commercial seed treatment formulation of fipronil.

Details: Number of Reps=4; Plot Size=6, 2.5 m long rows spaced 0.5 m apart; Wheat variety Superb. All seed planted by hand at 1 seed/1.75 cm. All seed treatment rates expressed as grams a.i./100 kg wheat seed. Treatment list: Tmt 1 Dividend XL RTA at 13 g a.i.; Tmt 2 Cruiser 350FS at 5 g a.i.; Tmt 3 Cruiser 350FS at 10 g a.i.; Tmt 4 containing mixture of Cruiser 350FS at 10 g a.i. with Regent 4SC at 5.0 g a.i.; Tmts 5-7 containing mixtures of Cruiser 350FS at 5 g a.i. with Regent 4SC at rates of 5.0, 1.0, 0.5 g a.i., respectively; Tmts 8-10 Regent 4SC at rates of 5.0, 1.0, 0.5 g a.i., respectively. Crop protection determined by stand counts at 7, 13, 21 and 28 days after planting (DAP) in 2007, expressed as % emergence of precision-planted seed. Relative crop yield determined by cutting off all the wheat heads 1 mm below the wheat head in a 1.5 m length of rows 3 and 4, and counting and weighing the seed heads. Wireworm mortality determined by bait trap samples placed within individual plots the following spring, 2008. The trial conducted under moderate wireworm pressure, with Agriotes obscurus the principal species.

Results. Mean percentage wheat stand in Treatments 1-10 at 28 DAP were, respectively: 75.6, 85.0, 87.5, 91.7, 91.3, 90.6, 90.0, 87.7, 87.7, 86.2. All wheat treated with the Cruiser 350FS plus Regent 4SC blends (Tmts 4-7) had acceptable stands at 28 DAP, with stands significantly greater than the Dividend only treatment (Tmt 1). Tmts 4-7 had numerically greater stands than wheat treated with Cruiser 350FS alone (Tmts 2 and 3). Wheat treated with Regent 4SC at various rates (Tmts 8-10) had similar stands to Tmts 2 and 3. The mean mass of wheat seed heads per 1.5 m of row in Treatments 1-10 were 381.2, 422.5, 425.3, 438.7, 445.3, 426.2, 434.8, 448.8, 439.0, 411.2. All treatments containing Cruiser 350FS alone at the higher rate tested (Tmt 3) and in combination with Regent 4SC (Tmt 4), Cruiser 350FS at the lower rate in combination with Regent 4SC at all rates (Tmts 5-7), and Regent 4SC alone at the two highest rates (Tmts 8-9) had significantly higher weights than the Dividend only treatment (Tmt 1). In the spring following the 2007 trial, Mean numbers of larger wireworms/replicate (>9 mm long) taken in bait traps in Treatments 1-10 were, respectively, 8.5, 5.5, 5.0, 1.0, 0.3, 1.5, 2.5, 0, 1.5, 1.3. Mean numbers of smaller wireworms (neonates<9 mm long) taken in bait traps in treatments 1-10 were, respectively, 1.8, 1.8, 2.3, 0, 0.5, 0.5, 0, 0, 0.5, 0.8. The results showed that the mixtures of Cruiser 350FS at the low rate of 5 g a.i., and Regent 4SC at rates of 5.0 or 1.0 (Tmts 5 and 6), provided both stand and yield protection and wireworm population reductions equal to or better than all the other treatments tested.

### EXAMPLE 4

Wheat field trial in 2008. The registered trademarks and other designations denote the following products: 1. Dividend@ XL RTA (Syngenta) Commercial seed treatment formulation of difenconazole; 2. Cruiser 350FS (Syngenta) Commercial seed treatment formulation of thiamethoxam; 3. Regent 4SC (BASF) Commercial seed treatment formulation of fipronil; 4 Vitavax Dual (Gustafson/Bayer) Commercial seed treatment formulation containing lindane and carbathiin; Tefluthrin 20FS (Syngenta) Seed treatment formulation of tefluthrin.

Details: Number of Reps=4; Plot Size=6, 2.5 m long rows spaced 0.5 m apart; Wheat variety AC Barrie. All seed planted by hand at 1 seed/1.75 cm. All seed treatment rates expressed as grams a.i./100 kg wheat seed. Treatment list: Tmt 1 Dividend XL RTA at 13 g a.i. (Check Second seed ‘CS’); Tmt 2 Mixture of Dividend XL RTA at 13 g a.i., Cruiser 350FS at 10 g a.i. and Regent 4SC at 50 g a.i. (First seed rate 1 ‘F1’ seed); Tmt 3 Mixture of Dividend XL RTA at 13 g a.i., Cruiser 350FS at 10 g a.i. and Regent 4SC at 5 g a.i. (First seed rate 2 ‘F2’); Tmt 4 Tefluthrin 20FS at 10 g a.i. (Repulsive Third seed ‘RT’ seed); Tmts 5-7 consist of a 1:1 ratio of CS seed alternating, respectively, with F1, F2 or RT seed; Tmts 8-9 consist of a 1:1 ratio of RT seed alternating, respectively, with F1 or F2 seed; Tmts 10 and 11 consist of a 1:1:1 ratio of CS and RT seed alternating, respectively, with F1 or F2 seed; and Tmt 12 Vitavax Dual at 61.7 g a.i. (lindane). Crop protection determined by stand counts at 14, 21 and 28 days after planting in 2007, expressed as % emergence of precision-planted seed. Relative crop yield determined by cutting off all the wheat heads 1 mm below the wheat head in a 1.5 m length of row 3, and counting and weighing the seed heads. Wireworm mortality determined by bait trap samples placed within individual plots the following spring, 2008. The trial conducted under moderate wireworm pressure, with Agriotes obscures the principal species.

Results. Treatments with only CS, F1, F2, RT and Vitavax Dual seed (Tmts 1-4 and 12) had percentage emergence of, respectively, 73.8, 95.5, 96.1, 89.4 and 93.3 at 28 DAP. Treatments with CS seed alternating with F1, F2 and RT (Tmts 5-7) had percentage emergence of, respectively, 93.3, 90.7 and 81.4. Treatments with RT seed alternating with F1 and F2 (Tmts 8 and 9) had percentage emergence of, respectively, 93.5 and 94.0. Treatments with CS and RT seed alternating with F1 or F2 (Tmts 10 and 11) had percentage emergence of, respectively, 90.1 and 90.1. At harvest, the mean mass of wheat seed heads per 1.5 m of row in Treatments 1-12 were 209.7, 231.3, 283.1, 269.3, 252.8, 270.3, 260.3, 282.4, 229.7, 251.0, 284.3, 210.1. The high emergence observed in Tmts 8 and 9 was expected, since wireworms would be repelled from the RT seeds to the adjacent First (F1 or F2) seeds without significant loss of stand. The high emergence observed in Tmts 5 and 6 was not expected, since wireworms should have been able to feed upon and reduce the emergence of the CS seed, as observed with Tmt 1. This was also seen in Example 1 above. This suggests that the presence of First seed alongside the CS seed impeded feeding by wireworms on the CS seed, even though wireworms had a 50% chance of visiting the CS seed first. Therefore, the impact of mixing CS and First seeds in terms of crop stand loss would not be as severe as anticipated and crop stand is preserved with reduced insecticide usage. The same was true of the mixtures of CS, RT and First seeds (Tmts 10 and 11). In terms of yield, there were no significant differences between treatments due to replicate variability, however, Tmts 1 and 7, which had the lowest stand counts, also had the lowest yields. Tmts 2-6 and 8-11 had numerically higher yields than the Vitavax Dual standard (Tmt 12). In the spring following the 2008 trial, Mean numbers of larger wireworms/replicate (>9 mm long) taken in bait traps in Treatments 1-12 were, respectively, 29.8, 0.8, 0.5, 29.0, 0.8, 2.5, 22.5, 1.5, 2.8, 2.0, 4.8, 5.5. Treatments 1, 4 and 7 had significantly higher numbers of larger wireworms than all other treatments, which in turn were not significantly different from each other. Mean numbers of smaller wireworms (neonates<9 mm long) taken in bait traps in treatments 1-12 were, respectively, 4.3, 0.0, 0.0 2.8, 0.0, 0.0, 2.8, 0.3, 0.0, 0.0, 0.3, 0.3. Treatments 1, 4 and 7 had significantly higher numbers of smaller wireworms than treatments 2-3, 5-6, and 8-12, which in turn were not significantly different from each other. These data show that the mixture of First seeds (F1 or F2) with the non-toxic CS seed and/or non-toxic but repellent RT seed reduces larger and neonate wireworm populations equal to or better than the Vitavax Dual standard.

### EXAMPLE 5

Laboratory trial 1 in 2008 duplicating the treatments tested in Example 4, but with the focus on mortality in an additional wireworm species.

Details: All wheat seed treatments are identical to those described in Example 4. Number of replicates=6. Seed was sown into 2.25 L plastic pots filled with soil (15 cm diameter), with 10 seeds sown in a line 1.75 cm apart at 2 cm depth. One day prior to seeding, 5 Limonius canus wireworms in an active feeding stage were placed into the pots to simulate a moderate to high wireworm field population. Germination and relative growth of the wheat seed was recorded over 14 days, after which time the seedlings were excavated and graded for damage. After the wheat was removed, the soil was carefully examined for remaining wireworms and the health of the wireworms was immediately assessed. Wireworms were weighed and their health again assessed on days 5 and 13.

Results. On day 13 after wireworms were extracted from the soil pots, Tmt 1 (Check Second seed ‘CS’) had 13% dead wireworms (most mortality in this Tmt believed to be through cannibalism). Tmts 2 (First seed rate 1 ‘F1’ seed) and 3 (First seed rate 2 ‘F2’ seed) had 60 and 54% dead wireworms, respectively, while Tmt 4 (Repulsive Third seed ‘RT’ seed) had 3% dead wireworms. Tmt 12, the Vitavax Dual standard, had 16% dead wireworms. Treatments with CS seed alternating with F1, F2 and RT (Tmts 5-7) had mortalities of 54, 57 and 7%, respectively, while treatments with RT seed alternating with F1 and F2 (Tmts 8 and 9) had mortalities of 57 and 57%, respectively. Treatments with CS and RT seed alternating with F1 or F2 seed (Tmts 10 and 11) had mortalities of 54 and 46%, respectively. All treatments with either F1 and F2 (treatments 2, 3, 5, 6, 8, 9, 10 and 11) had additional wireworms showing signs of insecticide-induced illness (respectively, 23, 24, 10, 23, 10, 17, 25, and 24% of wireworms) that has been shown in the past to eventually lead to death.

On day 208 after wireworms were extracted from the soil pots, using Abbott's formula to correct for dead or missing wireworms in the untreated check (Tmt 1), the percentage of dead wireworms in Tmts 1-12 were, respectively, 0; 90; 88; 0; 83; 88; 0; 83; 88; 88; 83; and 17%. These data show that wireworms exposed to treatments containing F1 or F2 seeds alone (Tmts 2-3), or alternating with one or both of CS and/or RT seeds, continued to die several weeks after removal from the soil pots. The data also show that the mortality effects of the F1 or F2 seeds alone were not reduced when alternating with one or both of CS and/or RT seeds, and mortality in these treatments was even higher than in the Vitavax Dual standard (Tmt 12).

### EXAMPLE 6

Laboratory trial 2 in 2008 testing hypothesis that higher ratios of Untreated Second Seeds: First Seeds will maintain or improve on the mortality of increasing levels of wireworms .

Details: Number of Reps=5. Wheat variety AC Barrie. All seed planted by hand at 1 seed/1.75 cm. Seed was sown into 2.25 L plastic pots filled with soil (15 cm diameter), with 10 seeds placed 1.75 cm apart at 2 cm depth. All seed treatment rates expressed as grams a.i./100 kg wheat seed. Treatment list: Tmt 1 Dividend XL RTA at 13 g a.i. (Check Second seed ‘CS’); Tmt 2 Mixture of Dividend XL RTA at 13 g a.i., Cruiser 350FS at 10 g a.i. and Regent 4SC at 5 g a.i. (First seed ‘F1’ seed); Tmt 3 CS alternating with F1 seed at 1:1 ratio; Tmt 4 CS alternating with F1 seed at 7:3 ratio; Tmt 5 CS alternating with F1 seed at 4:1 ratio; Tmts 1-5 had 0 wireworms per pot; Tmts 6-10 the same as Tmts 1-5 except with 2 wireworms/pot; Tmts 11-15 the same as Tmts 1-5 except with 5 wireworms/pot; Tmts 15-20 the same as Tmts 1-5 except with 10 wireworms/pot; One day prior to seeding, Limonius canus wireworms in an active feeding stage were placed into the pots to simulate low, moderate and high wireworm field populations. Germination and relative growth of the wheat seed was recorded over 14 days, after which time the seedlings were excavated and graded for damage. After the wheat was removed, the soil was carefully examined for remaining wireworms and the health of the wireworms was immediately assessed. Wireworms were weighed and their health again assessed on days 7 and 14.

Results. At excavation, the percentage of healthy wheat plants in pots were: Tmts 1-5 (0 wireworms/pot), respectively, 100, 100, 98, 100, 100; Tmts 6-10 (2 wireworms/pot), respectively, 82, 98, 98, 88, 86; Tmts 11-15 (5 wireworms/pot), respectively, 34, 92, 85, 71, 60; Tmts 16-20 (10 wireworms/pot), respectively, 8, 88, 70, 44, 54. Where treatments contained both CS and F1 seeds in various ratios, as in Tmts 8-10 (2 wireworms/pot); Tmts 13-15 (5 wireworms/pot); and Tmts 18-20 (10 wireworms/pot), the combined mean number of wheat plants killed per wireworm was, respectively: 0.93, 1.12 and 0.88. At 14 days after wireworms were recovered from the treatment pots, the percentage of wireworms dead or moribund (likely to die) in the various treatments were: Tmts 6-10 (2 wireworms/pot), respectively, 20, 50, 60, 75, 50; Tmts 11-15 (5 wireworms/pot), respectively, 0, 70, 64, 52, 48; Tmts 16-20 (10 wireworms /pot), respectively, 29, 85, 83, 80, 76. Limonius canus is known to be cannibalistic, and mortality in the untreated wheat plots (Tmts 6 and 16) can be attributed at least in part to this activity. Where treatments contained F1 seeds in specific ratios with CS seeds, the percentage of dead or moribund wireworms generally increased as wireworm density increased, with the 10 wireworm/pot treatments having consistently the highest mortality and morbidity. In the 10 wireworm/pot treatments, wireworm mortality and morbidity declined only slightly as the CS:F1 ratio increased. These data suggest that higher CS:F1 ratios of seed can be used to kill higher resident wireworm populations, probably more efficiently than at lower population levels.

### EXAMPLE 7.

Attract & Kill Potato field trial in 2007. The registered trademarks and other designations denote the following products: 1. Dividend@ XL RTA (Syngenta) Commercial seed treatment formulation of difenconazole; 2. Maxim PSP (Syngenta) Commercial seed treatment formulation of fludioxonil; 3. Cruiser 350FS (Syngenta) Commercial seed treatment formulation of thiamethoxam; 4. Regent 4SC (BASF) Commercial seed treatment formulation of fipronil; 5. Thimet 15G BASF) Commercial granular formulation of phorate; 6. Pyrinex 480EC (UAP) Commercial liquid formulation of chlorpyrifos.

Details: Number of Reps=4; Plot Size=3, 5.0 m long rows spaced 1.0 m apart; Potato variety Chieftain. Wheat variety Superb. All potato seed pieces cut, dusted with Maxim PSP at 2.5 g a.i./100 kg seed, and planted by hand at 1 seed piece/30 cm. Wheat, treated with various insecticides was sprinkled by hand into opened furrows at planting to act as an attract and kill (A&K) method for controlling wireworms. All wheat seed treated with Dividend XL RTA at 13 g a.i./100 kg wheat seed. Wheat seed was sown in 10 cm wide bands at rates of 1.5 or 3 seeds per 1.75 cm of open furrow. All wheat seed treatment rates expressed as grams a.i./100 kg wheat seed. Treatment list: Tmt 1 Maxim PSP treated potato seed; Tmt 2 Maxim PSP treated potato seed and Dividend XL RTA treated wheat seed at 3 seeds/1.75 cm row; Tmt 3 Thimet 15 G as granular in-furrow band at 32.3 g a.i./100 m row; Tmt 4 Pyrinex 480EC as in-furrow spray at 10.4 g a.i./100 m row; Tmts 5-8 A&K wheat seed treated with Cruiser 350FS at 10 g a.i. and Regent 4SC at 50.0, 5.0, 1.0 or 0.5 g a.i., respectively at 3 seeds/1.75 cm row; Tmts 9-12 A&K wheat seed treated with Regent 4SC at 50.0, 5.0, 1.0 or 0.5 g a.i., respectively at 3 seeds/1.75 cm row; Tmt 13 A&K wheat seed treated with Cruiser 350FS at 10 g a.i. at 3 seeds/1.75 cm row; Tmt 14 A&K wheat seed treated with Cruiser 350FS at 10 g a.i. and Regent 4SC at 50.0 g a.i. at 1.5 seeds/1.75 cm row. Crop protection determined by harvesting potatoes from middle potato row in each treatment at 100 days after planting, and grading for wireworm holes. Wireworm mortality determined by bait trap samples placed within individual plots the following spring, 2008. The trial conducted under moderate wireworm pressure, with Agriotes obscurus the principal species.

Results. Mean number of wireworm holes per tuber at harvest in Treatments 1-14 were, respectively, 2.30, 6.63, 0.02, 0.27, 0.34, 0.32, 0.52, 1.90, 0.10, 0.34, 0.41, 0.32, 3.56, 0.16. Number of wireworms taken in bait traps in spring, 2008 in Treatments 1-14 were, respectively, 12, 27, 7, 5, 0, 3, 4, 14, 0, 0, 8, 3, 20, 0. These results show that planting wheat seed treated with insecticide blends containing Cruiser 350FS at 10 g a.i. and Regent 4SC at 50.0, 5.0, 1.0 g a.i./100 kg seed (Tmts 5-7), or Regent 4SC alone at 50.0, 5.0, 1.0 and 0.5 (Tmts 9-12) at 3 seeds/1.75 provided wireworm damage control and wireworm mortality similar to the Canadian industry standards Thimet 15 G and Pyriniex 480EC. Tmt 14 shows that the number of wheat seeds needed for wireworm damage control and wireworm mortality in A&K strategies in potatoes can be reduced by at least 50%. The amounts of active ingredients/ha of all insecticides used in Tmts 3-14 are, respectively, 3230.0, 1040.0, 39.1, 9.8, 7.2, 6.8, 32.6, 3.26, 0.65, 0.33, 6.51, 19.55. The low numbers of wireworms caught in bait traps in most of the A&K treatments suggests most wireworms in the plots visited the treated wheat after planting, and ultimately died. This was true at A&K seeding rates of 1.5 or 3.0 seeds/1.75 cm.

The present invention has been described with regard to a plurality of illustrative embodiments. However, it will be apparent to persons skilled in the art that a number of variations and modifications can be made without departing from the scope of the invention.

### REFERENCES

Doane, J. F., Y. W. Lee, J. Klinger, N. D. Westcott. 1975. The orientation response of Ctenicera destructor and other wireworms (Coleoptera: Elateridae) to germinating grain and to carbon dioxide. Can. Entomol. 107: 1233-1252

Vernon, R. S.; Kabaluk, J. T.; Behringer, A. M. 2000. Movement of Agriotes obscurus (Coleoptera: Elateridae) in strawberry (Rosaceae) plantings with wheat (Gramineae) as a trap crop. Can. Ent. 132: 231-241.

Van Herk, W; Vernon, R. 2007. Soil bioassay for studying behavioural responses of wireworms (Coleoptera: Elateridae) to insecticide-treated wheat seed. Environ. Entomol. 36 (6): 1441-1449.

Van Herk, W; Vernon, R; Tolman, J; Ortiz Saavedra, H. 2008. Relative efficacies of various insecticides following topical application to the wireworm, Agriotes obscurus (Coleoptera: Elateridae). J. Econ. Entomol. 101 (2): 375-383.

Vernon, R. S.; Kabaluk, J. T.; Behringer, A. M. 2003. Aggregation of Agriotes obscurus (Coleoptera:Elateridae) at cereal bait stations. Can. Ent. 135: 379-389.

Vernon, R. S. 2005. Aggregation and mortality of Agriotes obscurus (Coleoptera: Elateridae) at insecticide-treated trap crops of wheat (Gramineae). J. Econ. Entomol. 98:1999-2005.

Vernon, R; van Herk, W, Tolman, J; Ortiz Saavedra, H; Clodius, M; Gage, B. 2008. Transitional sublethal and lethal effects of insecticides following dermal exposures to five economic species of wireworms (Coleoptera: Elateridae). J. Econ. Entomol. 101 (2): 365-374.

Vernon, R. S.; van Herk, W.; Moffat, C.; Harding, C. 2006. European wireworms (Agriotes spp.) in North America: Toxicity and repellency of novel insecticides in the laboratory and field. Proceedings of 5th meeting of the sub-group “Soil Insect Pests” of the IOBC/WPRS Working Group “Entomopathogens and Entomoparasitic Nematodes at Auer/Ora (Italy), 2006. Bull. 30: 35-41.

1-64. (canceled)

65. A combination of seeds for controlling insect pests, the combination comprising:
a first seed treated with at least one insecticide; and
a second seed for attracting and/or directing insect pests to the first seed.

66. The combination of claim 65, wherein the at least one insecticide on the first seed is a member selected from the group consisting of: an insecticide adapted for causing a lethal or non-lethal toxic effect on the insect pests; an insecticide adapted for reducing insect-caused damage to germinating seed and subsequent crop stand, yield and quality; an insecticide adapted for reducing populations of insect pests in various life stages; an insecticide adapted for both reducing damage to germinating seed and subsequent crop stand, yield and quality and for reducing populations of insect pests in various life stages; and an insecticide adapted for reducing populations of maturing wireworm and/or neonate wireworm.

67. The combination of claim 66, wherein the at least one insecticide is adapted for reducing insect-caused damage to germinating seed and subsequent crop stand, yield and quality and the at least one insecticide is a neonicotinoid insecticide and/or a phenyl pyrazol insecticide.

68. The combination of claim 67, wherein the neonicotinoid insecticide is a member selected from the group consisting of thiamethoxam, clothianidin, acetamiprid, thiacloprid, nithiazine, nitenpyram and imidacloprid, and the phenyl pyrazol insecticide is fipronil.

69. The combination of claim 66, wherein the at least one insecticide is adapted for reducing populations of insect pests in various life stages or is adapted for both reducing damage to germinating seed and subsequent crop stand, yield and quality and for reducing populations of insect pests in various life stages, and the at least one insecticide is fipronil or a blend of a neonicotinoid insecticide and fipronil.

70. The combination of claim 69, wherein the neonicotinoid insecticide is a member selected from the group consisting of thiamethoxam, clothianidin, acetamiprid, thiacloprid, nithiazine, nitenpyram and imidacloprid.

71. The combination of claim 65, wherein the second seed is a member selected from the group consisting of: an untreated seed adapted to produce a chemical for attracting insect pests; a treated seed treated with a seed health agent comprising an additive for maintaining the health of the second seed to improve germination and production of a chemical for attracting insect pests; and a treated seed treated with a behavior modification agent for manipulating a behavior of the insect pests for ultimately directing the insect pests to the first seed.

72. The combination of claim 71, wherein the chemical is CO₂.

73. The combination of claim 71, wherein the seed health agent further comprises a non-lethal dose insecticide.

74. The combination of claim 71, wherein the behavior modification agent comprises a synthetic pyrethroid.

75. The combination of claim 74, wherein the synthetic pyrethroid is at least one member selected from the group consisting of tefluthrin, allethrin, bifenthrin, cyfluthrin, cyhalothrin, cypermethrin, deltamethrin, esfenvalerate, fenpropathrin, fluvalinate, permethrin, resmethrin, tetramethrin and tralomethrin.

76. The combination of claim 65, wherein a ratio of the first seed to the second seed is a member selected from the group consisting of: from about 1:10 to about 10:1 and from about 1:5 to about 5:1.

77. The combination of claim 65, further comprising a third seed of a different type to the second seed and the first seed, and wherein a ratio of the first seed to the second seed to the third seed is a member selected from the group consisting of: from about 1:10:10 to about 10:1:10 to about 10:10:1 and from about 1:1:1 to about 1:1:5.

78. The combination of claim 65, wherein the insect pest is a soil insect pest selected from the group consisting of: wireworms, nematodes, pillbugs, millipedes, centipedes, earwigs, seed corn maggot, cabbage root maggot, turnip maggot, corn rootworms, white grubs, corn root aphids, cutworms, june beetles, chafers, hunting billbugs, lesser cornstalk borer, mole crickets, white-fringed beetle, seed corn beetles, corn root aphids and sod webworm.

79. The combination of claim 67, wherein the neonicotinoid insecticide applied to the first seed is applied at a rate from about 5.0 to about 30.0 g a.i./100 kg of seed, and the phenyl pyrazol is applied at a rate from about 0.5 to about 5.0 g a.i./100 kg of seed.

80. The combination of claim 74, wherein the synthetic pyrethroid applied to the second seed is applied at a rate from about 10.0 to about 20.0 g a.i./100 kg of seed.

81. A method of controlling insect pests in crops comprising:
planting a first seed treated with at least one insecticide, and
planting a second seed for attracting and/or directing the insect pests toward the first seed.

82. The method of claim 81, wherein the second seed is planted proximate to the first seed for attracting and/or directing the insect pests toward the first seed.

83. The method of claim 81 further comprising:
planting a third seed, different to the second seed, among the first and the second seeds for attracting and/or directing the insect pests to the first seed.

84. A method of controlling wireworms, the method comprising:
planting, in the presence of wireworms, a plant propagation material treated with a neonicotinoid insecticide, in an amount effective to induce a moribund state in wireworms, and a phenylpyrazol insecticide in an amount effective to induce a latent lethal effect on wireworms.
